(19) United States
(12) Patent Application Publication
(10) Pub. No.: US 2014/0111859 A1
(43) Pub. Date: Apr. 24, 2014

(54) SCRATCH RESISTANT POLARIZING ARTICLES AND METHODS FOR MAKING AND USING SAME

(71) Applicant: Corning Incorporated, Corning, NY (US)

(72) Inventors: Franck Manuel Duraes, Dordives (FR); David Henry, Fontaine le Port (FR)

(73) Assignee: Corning Incorporated, Corning, NY (US)

(21) Appl. No.: 14/050,776

(22) Filed: Oct. 10, 2013

Related U.S. Application Data
(60) Provisional application No. 61/716,478, filed on Oct. 19, 2012.

(51) Int. Cl. G02B 5/30

(52) U.S. Cl. CPC G02B 5/305
USPC 359/487.02; 427/163.1

(57) ABSTRACT

Disclosed herein are light polarizing articles that include a substrate, a light polarizing layer disposed on a surface of the substrate, a thick polymer layer disposed on the light polarizing layer, and at least one anti-scratch layer disposed on the thick polymer layer. The thick polymer layer serves as a buffer layer that, when combined with a thin abrasion-resistant coating, permits substantially improved resistance to scratching and indentation. The improved indentation resistance is exhibited even when being indented with sharp objects. The light polarizing articles can be used, for example, as ophthalmic products and in display devices. Methods of making and using the light polarizing articles are also disclosed.

### CROSS-REFERENCE TO RELATED APPLICATIONS

This application claims the benefit of priority of U.S. Provisional Application Ser. No. 61/716,478 filed on 19 Oct. 2012 the contents of which are relied upon and incorporated herein by reference in their entirety as if fully set forth below.

### TECHNICAL FIELD

The present disclosure relates generally to light polarizing articles. More particularly, the various embodiments described herein relate to light polarizing articles having improved scratch and indentation resistance, as well as to methods of making and using the articles.

### BACKGROUND

There is significant interest in light polarizing articles in part because of their unique ability to selectively eliminate glare that is reflected from smooth horizontal surfaces (e.g., water, ice, and the like).

Dichroic dye materials are well-suited for use in light polarizing articles, such as ophthalmic products and displays, because such materials, when properly oriented, can preferentially transmit light that is polarized in a particular direction. When dichroic dyes are disposed on a substrate in situ, however, the dichroic dye layer can suffer from poor durability. For example, even after being insolubilized and stabilized, the polarizing dichroic dye layer can be damaged by scratches or indentations. When this happens, the dye layer can be at least partially removed in the scratched or indented region, leading to a cosmetically unacceptable, visible/colorless spot on the substrate. These drawbacks are particularly exacerbated when glass substrates are used.

A number of technologies have been developed to provide increased scratch or indentation resistance, but each approach suffers from other drawbacks and/or does not provide an adequate level of scratch and/or indentation resistance. As one example, urethane-based laminate films have been used to provide improved indentation protection, but these films can easily delaminate from the remainder of the light polarizing article when exposed to moisture or sweat.

As an alternative to laminates, the remaining approaches involve a thin (i.e., less than 5 micrometers) anti-scratch or hard coat layer deposited as a monolayer or multi-layer on a stabilized dichroic dye layer (or on an adhesion promoting primer layer that is applied to the dichroic dye layer). While these approaches may provide improved scratch or indentation resistance to light polarizing articles formed from plastic substrates, they generally fail when more rigid glass substrates are used. Without intending to be bound by any particular theory, it is believed that plastic substrates are prone to deformation when scratched or indented and are thus able to dissipate at least a part of the compression stress induced in the dichroic dye layer by the scratch or indentation. In contrast, an “anvil effect” is observed when highly rigid substrates are used. That is, as an indenter approaches the rigid substrate, the stress field produces cracks, delamination, or complete destruction of the dichroic dye layer. In some cases, the dichroic dye layer is partially or completely removed from the substrate, leading to a transparent colorless spot on a dark colored background, which is aesthetically unacceptable.

There accordingly remains a need for technologies that provide light polarizing articles with improved resistance against scratches and indentations. It would be particularly advantageous if such technologies did not adversely affect other properties or introduce new deficiencies to the articles. It is to the provision of such technologies that the present disclosure is directed.

### BRIEF SUMMARY

Disclosed herein are light polarizing articles that offer improved scratch and/or indentation resistance, as well as methods of making and using the articles.

One type of light polarizing article includes (i.e., comprises) a light transmitting substrate, a light polarizing layer disposed on a surface of the light transmitting substrate, and a protective multilayer disposed on the light polarizing layer. The light polarizing layer can include a dichroic dye. The protective multilayer can include a thick polymeric first layer disposed on the light polarizing layer and a thin abrasion resistant second layer disposed on the thick polymeric first layer.

One type of method for making a light polarizing article includes the steps of providing a light transmitting substrate, forming a light polarizing layer on at least a portion of a surface of the light transmitting substrate, forming a thick polymeric first layer on the light polarizing layer, and forming a thin abrasion resistant second layer on the thick polymeric first layer.

It is to be understood that both the foregoing brief summary and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic illustration of an exemplary light polarizing article.

FIG. 2 is a schematic illustration of another exemplary light polarizing article.

FIG. 3 is a scanning electron microscope (SEM) image of a cross-section of a polarizing lens prepared in accordance with EXAMPLE 1.

FIG. 4 is a SEM image of a cross-section of a polarizing lens prepared in accordance with COMPARATIVE EXAMPLE 3.

These and other aspects, advantages, and salient features will become apparent from the following detailed description, the accompanying drawings, and the appended claims.

### DETAILED DESCRIPTION

Referring now to the figures, wherein like reference numerals represent like parts throughout the several views, exemplary embodiments will be described in detail. Throughout this description, various components may be identified having specific values or parameters. These items, however, are provided as being exemplary of the present disclosure. Indeed, the exemplary embodiments do not limit the various aspects and concepts, as many comparable parameters, sizes, ranges, and/or values may be implemented. Similarly, the terms “first,” “second,” “primary,” “secondary,” “top,” “bottom,” “distal,” “proximal,” and the like, do not denote any order, quantity, or importance, but rather are used to distinguish one element from another. Further, the terms “a,” “an,” and “the” do not denote a limitation of quantity, but rather denote the presence of “at least one” of the referenced item.

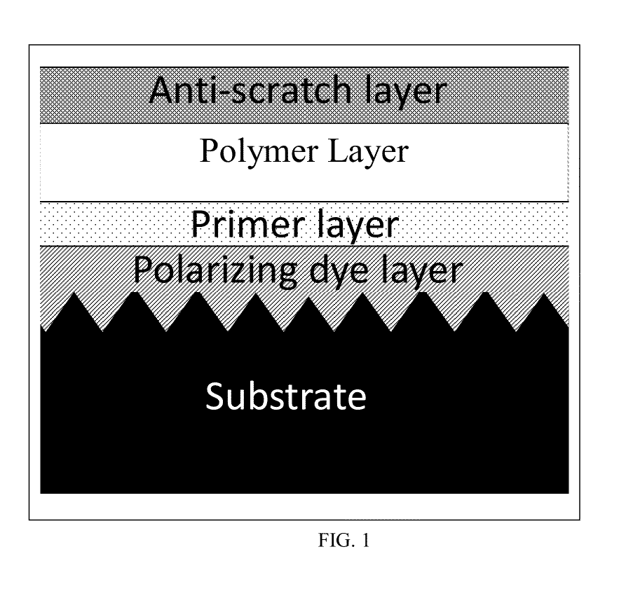

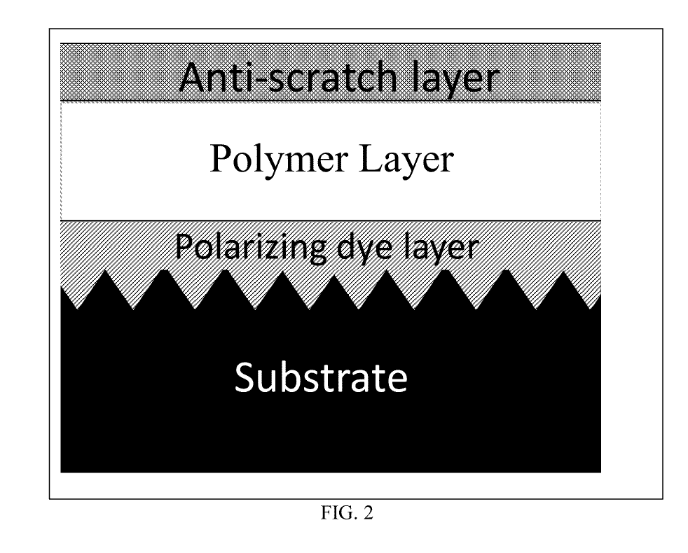

The light polarizing articles described herein generally include a light transmitting substrate, a light polarizing layer, comprising a polarizing dye, disposed on at least a portion of a surface of the substrate, and a protective multilayer that is disposed on the light polarizing layer. The protective multilayer generally includes at least a thick first layer of a polymeric material disposed on the light polarizing layer and a thin second layer of an abrasion resistant material that is disposed on the thick first layer. A light polarizing article having (i.e., comprising) this general structure is shown in FIG. 1. In certain implementations, an adhesion promoting primer layer may be interposed between the light polarizing layer and the thick polymeric first layer of the protective multilayer. This type of light polarizing article is generically shown in FIG. 2.

The light transmitting substrate can be formed from a variety of materials, including glass (e.g., fused silica, a silicate, a borosilicate, an aluminosilicate, or a boroaluminosilicate, which optionally can comprise one or more alkali and/or alkaline earth modifiers), transparent glass-ceramics (e.g., a material having both a glassy phase and a ceramic phase), crystalline inorganic materials (e.g., CaF₂, MgF₂, and the like), polymeric materials (e.g., polyamides, polyesters, polyimides, polysulfones, polycarbonates, polyurethanes, polyurethane-ureas, polyolefins, phenol resins, epoxy resins, copolymers comprising at least one of the foregoing, and the like), and the like.

By way of illustration, inorganic glass materials that can be used to form the substrate include those described in U.S. Pat. Nos. 4,839,314; 4,404,290 and 4,540,672, the contents of which are incorporated herein by reference in their entireties as if fully set forth below. Another illustrative class of glass materials include those high refractive index glass materials disclosed in U.S. Pat. Nos. 4,742,028 and 6,121,176, the contents of which are incorporated herein by reference in their entireties as if fully set forth below.

With respect to transparent glass-ceramics, illustrative glass-ceramic materials that can be used to form the substrate include those where the glass phase is formed from a silicate, borosilicate, aluminosilicate, or boroaluminosilicate, and the ceramic phase is formed from β-spodumene, β-quartz, nepheline, kalsilite, or carnegieite.

Similarly, illustrative polymers that can be used to form the substrate include homopolymers or copolymers of polyol (allyl carbonate) monomers, an example of which is the diethylene glycol bis(allyl carbonate) material sold under the trademark CR-39 by PPG Optical Products. Another illustrative class of polymers includes homopolymers and copolymers of a mono- or poly-functional (meth)acrylate, an example of which includes those materials sold under the trade mark SPECTRALITE by Sola International Incorporated. Another illustrative class of polymers includes homopolymers or copolymers of a polyurethane-urea, examples of which are those materials sold under the trademarks TRIVEX and NXT sold by PPG Optical Products and Intercast Europe SpA, respectively. Another illustrative class of polymers includes homopolymers or copolymers of a thiolene, an example of which includes those materials sold under the trademark FINALITE by Sola International Incorporated. Another illustrative class of polymers includes homopolymers or copolymers of a thiourethane, an example of which includes those materials sold as the MR series by Mitsui Chemicals. Still another illustrative class of polymers includes homopolymers or copolymers of a thioepoxy. Yet another illustrative class of polymers includes homopolymers or copolymers of carbonates derived from bisphenol-A and phosgene, an example of which are those materials sold under the trade mark LEXAN by SABIC Innovative Plastics.

The light transmitting substrate may adopt a variety of shapes. Additionally, the surface of the substrate on which the various components mentioned above are disposed can be planar or contoured. Thus, for example, the substrate may be a planar sheet, a cylindrical blank, a blank having at least one contoured surface, and the like.

In certain implementations, the light transmitting substrate can be photochromic, colored, coated with a functional coating (e.g., anti-reflective coating, a hardcoat, a photochromic coating, a tinted color coating, a UV filtering coating, an infrared absorbing coating, an adhesion promoting layer, a dye-compatibilizing layer, a dye-orienting layer, and the like), or the like. Those skilled in the art to which this disclosure pertains will recognize how to impart such features to the substrate.

The light polarizing layer, which is disposed on at least a portion of a surface of the light transmitting substrate, provides the polarizing effect to the light polarizing articles described herein. The light polarizing layer generally includes a dichroic dye as the active component, but can include non-active components (among which include adhesion promoting agents, plasticizers, non-polarizing dyes and surfactants for imparting a desirable color or hue to the final article, and the like) as long as these components (i) do not negatively impact the adhesion of the light polarizing layer to the other layers in the structure of the article, and (ii) do not negatively impact the polarizing effect of the dichroic dyes.

By way of illustration, dichroic dyes that can be used to form the light polarizing layer include those described in U.S. Pat. Nos. 2,400,877 and 6,245,399, the contents of which are incorporated herein by reference in their entireties as if fully set forth below.

The dichroic dye in the light polarizing layer will generally be oriented along one direction on the surface of the substrate to provide the desired polarization effect. In certain implementations, such as those shown in FIGS. 1-2, in order to achieve the directionality of the dichroic dye, the surface of the substrate (or the outermost optional functional layer thereon) will comprise a plurality of microgrooves, and the polarizing layer will be disposed in and on the microgrooves (formed or deposited in situ, e.g., from a solution of the polarizing dye as described in U.S. Pat. No. 2,400,877). The microgrooves can be substantially parallel to each other to promote the most efficient orientation of the dichroic dye molecules. Further, to minimize the visibility of the microgrooves, the width and depth of the grooves should be less than or equal to about 1 micrometer (μm). In such implementations, the light polarizing layer will include at least one dichroic dye that is capable of being oriented in the direction of the microgrooves after being disposed on the surface of the substrate.

As stated above, the protective multilayer is disposed on the light polarizing layer. The protective multilayer will include at least a first layer (i.e., layer closest to the substrate) that is thick and formed from a polymer, and a second layer (i.e., layer farther from the substrate than the first layer) that is thin and formed from an abrasion resistant material.

The first layer will generally have a thickness of at least about 20 μm. In many implementations, the thickness will be between about 20 μm and about 100 μm. In specific implementations where overall thickness of the final article is balanced with the level of protection provided by the protective multilayer, the thickness of the first layer will be about 40 μm to about 60 μm.

There is no particular limitation on the type of polymer used to form the first layer. In most implementations, however, the polymerized layer will have a pencil hardness of at least 1H, as measured using ASTM test procedure D3363-05, entitled “Standard Test Method for Film Hardness by Pencil Test,” which is incorporated herein by reference in its entirety as if fully set forth below. Those skilled in the art to which this disclosure pertains can select such a polymer.

By way of example, in situations where manufacturing ease and convenience are important, the polymer can be a thermally-cured or radiation-curable composition that does not involve the use of a solvent. Such polymer systems can include, for example, electron beam (EB) or ultraviolet (UV) curable compositions that result in the formation of a (meth)acrylate, epoxy or vinyl ether, epoxy/(meth)acrylate hybrid, a thiolene, or the like. For convenience, the term “(meth)acrylate” is used herein to include acrylate, methacrylate and combinations or mixtures thereof. Exemplary (meth)acrylate materials include those radiation-curable (meth)acrylates formed from a composition comprising from about 40 weight percent (wt %) to about 90 wt % reactive diluent. The reactive diluent can comprise a vinylic monomer (e.g., hydroxyl ethyl methacrylate, isobornyl acrylate, acrylic acid, tetrahydrofurfuryl acrylate, mixture or blends thereof, or the like) or diethylene glycol di(meth)acrylate, ethoxylated bisphenol A di(meth)acrylate, 1,6-hexanediol di(meth)acrylate, neopentyl glycol di(meth)acrylate, polyethylene glycol di(meth)acrylate, propoxylated neopentyl glycol di(meth)acrylate, tetraethylene glycol di(meth)acrylate, triethylene glycol di(meth)acrylate, tripropylene glycol di(meth)acrylate, trimethylolpropane tri(meth)acrylate, ethoxylated trimethylolpropane tri(meth)acrylate, tris (2-hydroxyethyl)isocyanurate tri(meth)acrylate, propoxylated glycerol tri(meth)acrylate, pentaerythritol tri (meth)acrylate, propoxylated pentaerythritol tri(meth)acrylate, pentaerythritol tetra(meth)acrylate, dipentaerythritol penta- or hexa-(meth)acrylate, or mixtures or blends thereof.

Turning now to the second layer of the protective multilayer, the thin second layer will generally have a thickness of less than or equal to about 10 μm. In many implementations, the thickness will be between about 1 μm and about 10 μm. In specific implementations where overall thickness of the final article is balanced with the level of protection provided by the protective multilayer, the thickness of the second layer will be about 1 μm to about 5 μm.

In general, any abrasion resistant material can be used to form the second layer. By way of illustration, the abrasion resistant material can be an oxide material such as silica, titania, zirconia, or the like. Another illustrative class of abrasion resistant materials includes radiation curable organic hardcoat materials, such as (meth)acrylate-based materials.

In certain implementations, such as the one shown in FIG. 2, the light polarizing articles can include a primer layer between the light polarizing layer and the thick polymeric first layer of the protective multilayer. The primer can serve to facilitate or increase adhesion between the light polarizing layer and the thick polymeric first layer.

In most implementations, the adhesion promoting primer layer is formed from a silane material. In such cases, the silane provides high humidity resistance that prevents moisture from penetrating and delaminating the interface between the light polarizing layer and the thick polymeric first layer. One illustrative class of silanes includes those that have a radical photopolymerizable functional group, such as trimethoxysilylpropyl methacrylate, trimethoxysilylpropyl acrylate, and the like.

Regardless of whether the articles include the optional adhesion promoting primer layer, the use of the protective multilayer in the light polarizing articles described herein results in substantially improved scratch resistance and indentation resistance. It should be noted that although the thick polymeric first layer of the protective multilayer can be formed from a material that does not exhibit any intrinsic scratch resistance properties, the resulting article exhibits increased scratch resistance and indentation resistance. For example, such an article can withstand scratching and/or indentation by a tungsten carbide tip under about 15 to about 20 Newtons of force without showing any visible scratching or destruction of the polarizing dye layer.

The light polarizing articles described herein can be used in a variety of applications. Examples of such applications include: ophthalmic products (e.g., prescription lenses, sunglasses, goggles, sun visors, and the like), display products (e.g., liquid crystal displays, including monitors and projectors); polarizing windows (e.g., for vehicles and buildings), and the like.

Methods of making the light polarizing articles described herein generally include the steps of providing a light transmitting substrate, disposing a light polarizing layer on a surface of the substrate, and disposing a protective multilayer on the light polarizing layer. In those situations where the optional adhesion promoting primer layer is implemented, however, the methods generally involve an additional step of disposing the adhesion promoting primer layer on the light polarizing layer prior to the step of disposing the protective multilayer.

The selection of materials used in the substrates, light polarizing layers, protective multilayers, and optional adhesion promoting primer layers can be made based on the particular application desired for the final light polarizing article. In general, however, the specific materials will be chosen from those described above for the light polarizing articles.

Provision of the light transmitting substrate can involve selection of the appropriate glass, transparent glass-ceramic, crystalline inorganic material, polymeric material, or other like object as-manufactured, or it can entail subjecting the as-manufactured object to a treatment in preparation for disposing the light polarizing layer thereon. Examples of such treatments include physical or chemical cleaning, physical or chemical strengthening, physical or chemical etching, physical or chemical polishing, annealing, shaping (including forming microgrooves thereon as described above), and/or the like. Such processes are known to those skilled in the art to which this disclosure pertains.

Once the light transmitting substrate has been selected and/or prepared, the light polarizing layer can be disposed on a surface thereof. Depending on the materials chosen, the light polarizing layer can be formed using a variety of techniques. In most implementations, the light polarizing layer will be disposed on the substrate as a liquid. In such cases, then, disposing the light polarizing layer can involve spray coating, spin-coating, dip-coating, inkjetting, sol-gel processing, or the like. Such processes are known to those skilled in the art to which this disclosure pertains.

In certain situations, the dichroic dye of the light polarizing layer can be insolubilized and/or stabilized. One way to achieve this involves subjecting the dye-coated substrate to an aqueous solution of a metal salt. U.S. Pat. No. 2,400,877 discloses methods and agents used for the insolubilization. One illustrative class of metal salts that can be used includes chlorides (e.g., AlCl₃, BaCl₂, CdCl₂, ZnCl₂, SnCl₂, and the like). Salts other than chlorides may also be used. Generally, metal salts used in the textile industry for insolubilizing dyes in water also can be used. It should be noted that the solution used for insolubilizing the dye molecules may be a buffered solution or dispersion containing multiple acids, salts and/or bases of various metals. For example, one combination used for insolubilizing certain sulphonic group-containing polarizing molecules is an aqueous dispersion including: (i) AlCl₃; (ii) Mg(OH)₂; and (iii) Ca(OH)₂, at a pH of about 4. The result of such insolubilization by metal salts is the precipitation of the polarizing dye molecules in the form of salts having low solubility in water around room temperature.

Such precipitated salts may have an unacceptable solubility in water at a relatively high temperature, or may be mobilized after prolonged exposure to sweat and/or another moisture source. Thus, in certain situations, it may be beneficial to further immobilize the dichroic dye molecules. This can be accomplished using polymer molecules distributed in the light polarizing layer. One category of polymers that can be used for this purpose is siloxanes. According to certain embodiments, after the initial insolubilization of the polarizing dye molecules, the layer of polarizing dye molecules is impregnated with a dispersion of a siloxane or a prepolymer of at least one siloxane. It is generally desired that the siloxane or siloxane prepolymer is allowed to penetrate into and distribute throughout the light polarizing layer. This impregnation can generally take from 1 to 20 minutes. Upon impregnation, it is desired in certain embodiments that the light polarizing layer is rinsed to avoid the formation of a separate layer of the siloxane and/or prepolymers thereof on the surface of the light polarizing layer. Without intending to be bound by any particular theory, it is believed that this could avoid the disorientation of the polarizing dye molecules caused by the further polymerization of any separate layer of siloxane. Upon impregnation and rinsing, it is desired in certain embodiments that the light polarizing layer is subjected to mild heat treatment by which the siloxane and/or prepolymer thereof distributed within the light polarizing layer are allowed to polymerize and/or crosslink, forming a polymer matrix which traps the dichroic dye molecules.

Exemplary siloxanes for use in this immobilization step include γ-aminopropyltrimethoxysilane; γ-aminopropyltriethoxysilane; N-β-(amino ethyl)-γ-aminopropyltrimethoxysilane; N-β-(amino ethyl)-γ-aminopropyltriethoxysilane; and mixtures or combinations thereof.

In certain cases, the above-described immobilization step using a siloxane can be repeated using a different siloxane. The additional immobilization can serve not only to further ensure that the dichroic dye molecules are oriented and fixed in place on the surface of the substrate, but also provide a more compatible interface between the light polarizing layer and the first layer of the protective multilayer.

Exemplary siloxanes for use in this additional immobilization step include polyepoxysiloxanes, poly(meth)acryloxysiloxanes, and the like.

In situations where the optional adhesion promoting primer layer is used, the next step entails disposing it on the light polarizing layer (which may include the optional above-described impregnated siloxanes). The optional adhesion promoting primer layer generally will be disposed on the light polarizing layer as a liquid. The same techniques described above for disposing the light polarizing layer on the substrate can also be used to dispose the adhesion promoting primer layer on the light polarizing layer.

Similarly, the first thick polymer layer of the protective multilayer can be disposed on the light polarizing layer (or the optional adhesion promoting primer layer) using the same techniques described above for disposing the light polarizing layer on the substrate.

The polymer-forming composition that is disposed on the light polarizing layer (or the optional adhesion promoting primer layer) can be polymerized via free-radical polymerization or cationic (or acid) polymerization. For example, UV-initiated free radical polymerization can be implemented on (meth)acrylate compositions, while cationic polymerization (involving the acid polymerization of an epoxy or vinyl ether group) can be implemented on epoxy or vinyl ether compositions, epoxy/(meth)acrylate hybrid compositions, or thiolene compositions.

In implementations involving the preparation of (meth)acrylate coatings, the polymer-forming compositions generally include a monomer and/or prepolymer containing at least one radically crosslinkable ethylenically unsaturated double bond (e.g., epoxy(meth)acrylate, polyester (meth)acrylate, urethane(meth)acrylate, melamine (meth)acrylate, carbonate (meth)acrylate, and the like) and a photopolymerization initiator (e.g., mono- or bisacylphosphine oxides, benzophenones, hydroxyacetophenones, phenylglyoxylic acid and its derivatives, mixtures of these photoinitiators, and the like).

The polymer-forming composition can also include a reactive diluent, such as a multi-functional (meth)acrylate. Examples of such reactive diluents include vinylic monomers, diethylene glycol di(meth)acrylate, ethoxylated bisphenol A di(meth)acrylate, 1,6-hexanediol di(meth)acrylate, neopentyl glycol di(meth)acrylate, polyethylene glycol di(meth)acrylate, propoxylated neopentyl glycol di(meth)acrylate, tetraethylene glycol di(meth)acrylate, triethylene glycol di(meth)acrylate, tripropylene glycol di(meth)acrylate, trimethylolpropane tri(meth)acrylate, ethoxylated trimethylolpropane tri(meth)acrylate, tris (2-hydroxyethyl)isocyanurate tri(meth)acrylate, propoxylated glycerol tri(meth)acrylate, pentaerythritol tri (meth)acrylate, propoxylated pentaerythritol tri(meth)acrylate, pentaerythritol tetra(meth)acrylate, dipentaerythritol penta- or hexa-(meth)acrylate, or mixtures or blends thereof.

The polymer-forming composition can also include a silane adhesion promoter. When used, this adhesion promoter can be used in the polymer-forming composition rather than separately (i.e., in the formation of the optional adhesion promoting primer layer). Thus, the choice of material for this optional component can be the same as those described above for the optional adhesion promoting primer layer.

In order to improve the shelf life of the polymer-forming composition, it may be beneficial to include certain additives, such as stabilizers and/or antioxidants. Flow control agents can be also added to the composition. Such materials are known to those skilled in the art to which this disclosure pertains.

The polymer-forming composition can be prepared to have a viscosity, as measured at about 20 degrees Celsius (° C.) of about 500 to about 10.000 mPa·s

Once the polymer-forming composition, as described above, is disposed on the on the light polarizing layer (or the optional adhesion promoting primer layer), the thin abrasion resistant second layer can be disposed in the thick polymeric first layer. In addition to the techniques described above for disposing the light polarizing layer on the substrate, the thin abrasion resistant second layer can be disposed using any of the variants of chemical vapor deposition (CVD) (e.g., plasma-enhanced CVD, aerosol-assisted CVD, metal organic CVD, and the like), any of the variants of physical vapor deposition (PVD) (e.g., ion-assisted PVD, pulsed laser deposition, cathodic arc deposition, sputtering, and the like). These processes, too, are known to those skilled in the art to which this disclosure pertains.

One implementation of the processes for producing the light polarizing articles described herein involves the following steps:

(A) providing a light transmitting substrate;

(B) forming a plurality microgrooves on a surface of the substrate by abrading the surface in a uniaxial direction;

(C) forming a light polarizing layer comprising a dichroic dye on at least a portion of the surface of the substrate;

(D) treating the product resulting from step (C) with an aqueous solution prepared from γ-aminopropyltrimethoxysilane and/or γ-aminopropyltriethoxysilane, this treatment being followed by a rinsing and a heat treatment between about 60° C. and about 140° C.;

(E) placing the product resulting from step (D) in contact with an aqueous solution of an epoxyalkyltrialkoxysilane, then rinsing in water followed by a condensation and/or partial polymerization of the epoxyalkyltrialkoxysilane, followed by a rinsing and a heat treatment between about 60° C. and about 220° C.;

(F) forming a thick polymeric first layer on the light polarizing layer by depositing a polymer-forming composition on the light polarizing layer, followed by reacting the polymer-forming composition to form the polymer, wherein the polymer-forming composition includes a pre-synthesized polymer or a precursor (e.g., monomers or oligomers) of the polymer; and

(G) depositing a thin abrasion resistant second layer over the thick polymeric first layer deposited in step (F).

In certain embodiments of this implementation, an adhesion promoting primer layer is applied between step (E) and step (F).

In certain overlapping or different embodiments of this implementation, the light transmitting substrate is a glass substrate.

In certain overlapping or different embodiments of this implementation, the microgrooves are at least substantially parallel.

In certain overlapping or different embodiments of this implementation, the light polarizing layer is formed in situ such that the dichroic dye abuts the microgrooves.

In certain overlapping or different embodiments of this implementation, the precursor of the polymer is a urethane (meth)acrylate prepolymer, which can provide toughness and abrasion resistance. In such embodiments, the urethane (meth)acrylates are aliphatic urethane acrylates (i.e., they contain no aromatic rings), so as to prevent yellowing and discoloration. The urethane (meth)acrylate prepolymers will generally have a number-average molecular weight (Mn) of about 500 to about 20,000 grams per mole (g/mol). In exemplary embodiments, the urethane (meth)acrylate prepolymers will have a Mn of about 750 to about 3000 g/mol.

In certain overlapping or different embodiments of this implementation, the polymer-forming composition will include 1,6-hexane diol di(meth)acrylate and/or trimethylolpropane tri(meth)acrylate as a reactive diluent.

In certain overlapping or different embodiments of this implementation, the viscosity of polymer-forming composition is about 1000 to about 2000 mPa·s.

The various embodiments of the present disclosure are further illustrated by the following non-limiting examples.

### EXAMPLES

### Example 1

### Part A

### Preparation of a UV-Curable Acrylic Coating Composition Enabling the Preparation of the Thick Polymeric First Layer

A coating liquid obtained by mixing about 90 mass parts of Ebecryl 264 (urethane acrylate oligomer made by Cytec Industries), about 40 mass parts of Ebecryl 294/25 (urethane acrylate oligomer made by Cytec Industries Inc.), about 20 mass parts of [3-(methacryloyloxy) propyl]trimethoxysilane (Dow Corning product Z-6030), about 49.2 mass parts of hexanedioldiacrylate, about 6.44 mass parts of Irgacure 184 (Ciba), and about 1.64 mass parts of Irgacure 819 (Ciba).

### Part B

### Preparation of the Polarizing Glass Lens

A cleaned chemically tempered glass lens (GS15, Corning) was brushed with a wheel having the appropriate shape and made of polyurethane foam. The wheel was imbibed with abrasive slurry in order to get parallel microgrooves on the surface of the coated lens.

The abrasive slurry used was an about 12 weight percent (wt %) mixture of water and micrometer-size alumina particles in order to provide a gentle abrasive brushing. The brush rotated at about 339 revolutions per minute (rpm). The force applied on the lens contacting the brush was about 2 kilograms (kg). The lens was supported in the holder and brought into contact with the brush and held in contact with the brush for about 15 seconds. Then the grooved lens was rinsed with deionized water and dried under an infra-red lamp at about 51° C. followed by a spin coating with about 2 grams (g) of an aqueous solution containing the polarizing dyes. The dye solution was a mixture of polarization dye solution (PDS) and activator A3070 (Corning SAS, France), with the amount of activator in the mixture being about 0.75 wt %. The dye solution was dispensed at about 165 rpm for about 4 seconds, then the spinning speed was increased to about 340 rpm for about 45 seconds and then to about 995 rpm for about 5 seconds.

At this step, the dyed lens exhibited a polarization efficiency of about 99.5% and a transmittance of about 15%.

Then the polarizing coating was stabilized by immersing the lens for about 30 seconds in an aqueous solution containing aluminum chloride, calcium hydroxide and magnesium hydroxide at about pH 3.5. This step converted the water soluble dye to its water insoluble form.

Next, the lens was dipped in an about 10 wt % aqueous solution of 3-aminopropyltriethoxysilane[919-30-2] for about 15 minutes, rinsed with deionized (DI) water 3 times and cured at about 125° C. for about 30 minutes.

After cooling, the lens was immersed in an about 2 wt % aqueous solution of 3-glycidoxypropyltrimethoxysilane[2530-83-8] for about 30 minutes and cured in an oven at about 125° C. for about 30 minutes.

After cooling, a 33×3 primer coating liquid (SDC Technologies, Inc.) was coated on the concave surface of the polarizing lens by spin coating at about 1000 rpm for about 45 seconds. Thereafter, the coated film was oven dried for about 5 minutes at room temperature and then about 30 minutes at about 100° C. The thickness of the primer layer (2) was about 2.1 μm.

Further, a thick polymer layer prepared from the UV-curable acrylic resin composition described in Part A above was applied by spin coating to the surface of the primer layer using a spin speed of about 500 rpm for about 7 seconds, followed by spinning at about 4700 rpm for about 0.8 seconds, and was cured by exposure to UV light from a fusion bulb D lamp at a belt speed of about 0.8 meters per minute (2 passes). UVA (320-390 nm) and UVV (395-445 nm) doses, measured by means of a Power Puck® radiometer, were about 10.808 millijoules per centimeter squared (mJ/cm²) and about 13.196 mJ/cm², respectively.

Following the UV curing, the lens was post cured by being heat treated for about 180 minutes in an oven at about 120° C., thereby forming a thick polymer layer on the polarizing film. The thickness of the thick polymer layer that was formed was about 60 μm.

The glass transition temperature of the thick polymer layer determined by differential scanning calorimetry (DSC) was about 25° C. (onset).

Finally, a thin abrasion resistant second layer, having a thickness of about 2.7 μm, was applied on top of the cured thick polymeric first layer. The thin abrasion resistant coating resin used is sold under the reference 56×1 from SDC Technologies, Inc. The resin was applied by spin coating with a spin speed of about 800 rpm for about 45 seconds and was cured by exposure to UV light from a fusion bulb H lamp at a belt speed of about 0.9 meters per minute (2 passes). UVA (320-390 nm) and UVV (395-445 nm) doses were about 4.630 mJ/cm² and about 6.244 mJ/cm², respectively.

At this step the total protective multilayer thickness was about 65 μm and the dyed lens exhibited a polarization efficiency of about 99% and a transmittance of about 14.5-15%.

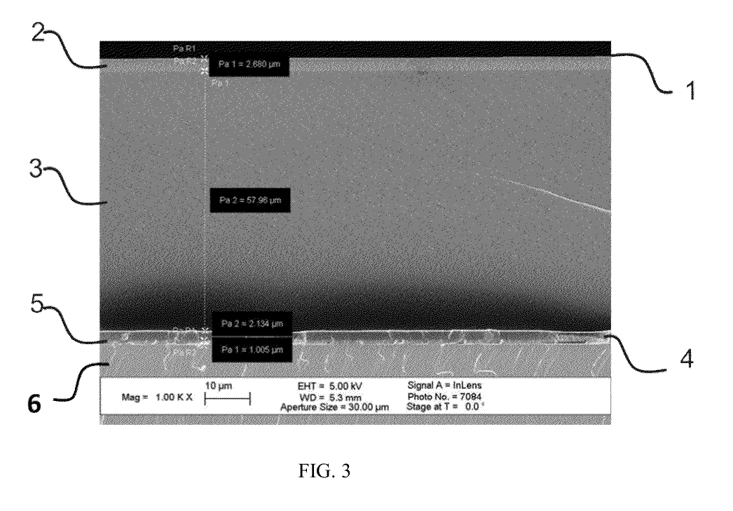

FIG. 3. is a scanning electron microscope (SEM) image (magnification: 1,000×) of a cross-section of a representative polarizing lens prepared in accordance with this example. The SEM image shows the different layers constitutive of the construct: antireflective coating (1), abrasion resistant coating (2), thick layer (3), adhesion primer (4), dichroic dye layer (5), and glass substrate (6).

### Comparative Example 2

The same process was reproduced as described in EXAMPLE 1, except that the thick polymeric first layer was omitted.

### Comparative Example 2

The same process was reproduced as described in EXAMPLE 1, except that the thin abrasion resistant second layer was omitted.

### Comparative Example 3

The same process was reproduced as described in EXAMPLE 1, except that the thick polymeric first layer and thick abrasion resistant second layer were replaced by multiple layers (up to 10 layers) of a commercially available abrasion resistant coating. Although an adequate protective effect was achieved, the lens exhibited unacceptable cosmetic defects.

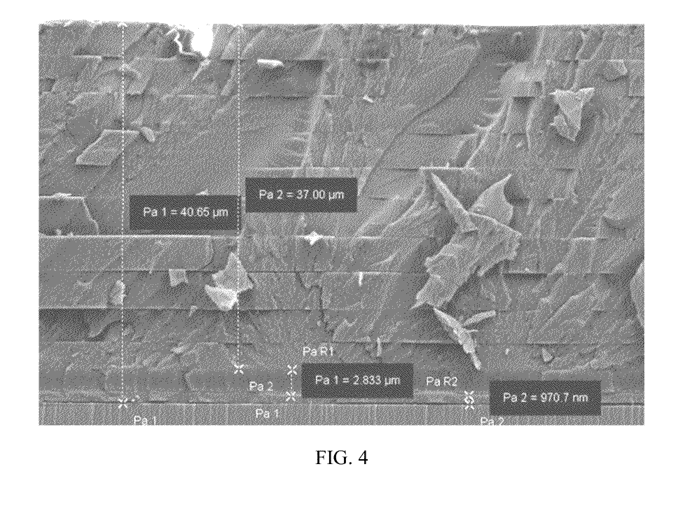

FIG. 4. is a SEM image (magnification: 1,000×) of a cross-section of a representative polarizing lens prepared in accordance with this example.

### Example 4

### Lens Characterization

Polarization Efficiency:

The polarization efficiency (P.eff) was determined by measuring the parallel transmittance (T//) and perpendicular transmittance (T^{⊥}) using a visible spectrophotometer and a polarizer. The Polarization efficiency was calculated using the following formula: Peff (%)=[(T//−T^{⊥})/(T//+T^{⊥})]×100.

Scratch and Indentation Resistance:

Scratch and indentation resistance test was performed using a sclerometer hardness tester (Hardness Test Pencil Models 318/318 S from Erichsen). Briefly, the test consisted of drawing a hemispherical tungsten carbide tip (having an about 0.75 mm radius) over the surface with a defined constant force.

A visual mark appearing on the surface after drawing the tungsten carbide tip at about a 5 Newton load indicated a fail of the surface hardness and was rated “X,” whereas lenses showing no scratches were rated “O”.

In a second step, the pressure on the tip was changed incrementally from about 5 to about 20 Newtons. The test result was visually evaluated to determine the load required to create a deep scratch in the dye layer or remove at least some of the polarizing dye from the lens, leading to transparent marks on a dark colored background (load at failure).

The lenses that exhibited scratch resistance above about 15 Newtons were rated “O,” whereas the lenses exhibiting scratches in the dye layer at loads lower than about 15 Newtons were rated “X.”

Adhesion:

The adhesion level was evaluated by trying to peel off the coatings by means of a standard adhesive tape after crosscuts were made according to ASTM D3359 method D. The adhesive performance of the polarizing lenses that were prepared was evaluated immediately following fabrication. Ratings was done according to ASTM D3359. Lenses that exhibited adhesion of between 4 B and 5 B were rated “O,” whereas lenses giving adhesion lower than 4 B were rated “X.”

Optical Quality:

Lenses that exhibited poor optical quality (presence of cosmetic defects or distortion) were rated “X,” whereas lenses showing good optical quality were rated “O.”

Results:

The polarization efficiency was about 99% for all samples.

The results of the above are given in Table 1. Table 1 compares the properties of the lenses made according to EXAMPLES 1-4, the latter three samples being labeled as “Comp Ex” 1-3 in Table 1. Ratings of “X” or “O” were used to indicate whether the sample passed or failed. Also scratching load at failure and adhesion rating according to ASTM D3359 are given.

As indicated in Table 1, the polarizing lenses of COMPARATIVE EXAMPLE 2 (Comp ex 1), in which no thick protective layer was applied, exhibited low surface scratch resistance, no dye layer protection against indentation, and low adhesion. Lenses of COMPARATIVE EXAMPLE 3 (Comp ex 2), in which no abrasion-resistant layer was applied, exhibited low surface scratch resistance as expected, unacceptable dye layer protection in spite of the 60 μm thick protective layer, and low adhesion. Lenses of COMPARATIVE EXAMPLE 4 (Comp ex 3), in which the protective layer was made by stacking 10 layers of a commercial abrasion resistant coating, exhibited good surface scratch resistance, efficient dye layer protection against indentation, but low adhesion and poor optical quality.

By contrast, the polarizing lenses of EXAMPLE 1 was evaluated as having good surface scratch resistance, high protection of the polarizing dye layer against indentation, high adhesion, and good optical quality.

TABLE 1

| | Surface scratch | | | |
|---|---|---|---|---|
| | resistance | Dry layer | Dry | |
| | (5 N max load) | protection | Adhesion | Optical quality |
| Example 1 | ◯ (>5N) | ◯ (18N) | ◯ (4-5B) | ◯ |
| Comp ex 1 | X (<1N) | X (3N) | X (0B) | ◯ |
| Comp ex 2 | X (<1N) | X (8N) | X (2B) | ◯ |
| Comp ex 3 | ◯(>5N) | ◯ (20N) | X (0B) | X |

While the embodiments disclosed herein have been set forth for the purpose of illustration, the foregoing description should not be deemed to be a limitation on the scope of the disclosure or the appended claims. Accordingly, various modifications, adaptations, and alternatives may occur to one skilled in the art without departing from the spirit and scope of the present disclosure or the appended claims.

What is claimed is:

1. A light polarizing article, comprising:
a light transmitting substrate;
a light polarizing layer disposed on a surface of the light transmitting substrate, wherein the light polarizing layer comprises a dichroic dye; and
a protective multilayer disposed on the light polarizing layer, wherein the protective multilayer comprises:
a thick polymeric first layer disposed on the light polarizing layer, wherein the thick polymeric first layer has a thickness of at least about 20 micrometers; and
a thin abrasion resistant second layer disposed on the thick polymeric first layer, wherein the thin abrasion resistant second layer has a thickness of less than or equal to about 10 micrometers.

2. The light polarizing article of claim 1, further comprising an adhesion promoting primer layer interposed between the light polarizing layer and the thick polymeric first layer of the protective multilayer.

3. The light polarizing article of claim 2, wherein the adhesion promoting primer layer comprises a silane.

4. The light polarizing article of claim 1, wherein the light polarizing layer further comprises a siloxane impregnated therein.

5. The light polarizing article of claim 1, wherein the thick polymeric first layer has a thickness of about 40 to about 60 micrometers.

6. The light polarizing article of claim 1, wherein the thin abrasion resistant layer has a thickness of about 1 to about 5 micrometers.

7. The light polarizing article of claim 1, wherein the thick polymeric first layer has a thickness of about 40 to about 60 micrometers and the thin abrasion resistant layer has a thickness of about 1 to about 5 micrometers.

8. The light polarizing article of claim 1, wherein the thick polymeric first layer comprises a radiation-curable (meth)acrylate.

9. The light polarizing article of claim 8, wherein the radiation-curable (meth)acrylate is formed from a composition comprising about 40 to about 90 weight percent of a reactive diluent vinylic monomer.

10. The light polarizing article of claim 9, wherein the reactive diluent vinylic monomer comprises hydroxyl ethyl methacrylate, isobornyl acrylate, acrylic acid, tetrahydrofurfuryl acrylate, or a mixture or blend thereof.

11. A light polarizing article, comprising:
a glass substrate;
a light polarizing layer disposed on a surface of the glass substrate, wherein the light polarizing layer comprises a dichroic dye and an impregnated siloxane; and
a protective multilayer disposed on the light polarizing layer, wherein the protective multilayer comprises:
a thick polymeric first layer having a thickness of about 40 to about 60 micrometers disposed on the light polarizing layer; and
a thin abrasion resistant second layer having a thickness of about 1 to about 5 micrometers disposed on the thick polymeric first layer.

12. The light polarizing article of claim 11, further comprising an adhesion promoting primer layer interposed between the light polarizing layer and the thick polymeric first layer of the protective multilayer.

13. A method of making a light polarizing article, the method comprising:
providing a light transmitting substrate;
forming a light polarizing layer comprising a dichroic dye on at least a portion of a surface of the light transmitting substrate;
forming a thick polymeric first layer on the light polarizing layer, wherein the thick polymeric first layer has a thickness of at least about 20 micrometers; and
forming a thin abrasion resistant second layer on the thick polymeric first layer, wherein the thin abrasion resistant layer has a thickness of less than or equal to about 10 micrometers.

14. The method of claim 13, further comprising forming a plurality of microgrooves on a surface of the light transmitting substrate by abrading the surface in a uniaxial direction before forming the light polarizing layer.

15. The method of claim 13, further comprising insolubilizing and stabilizing the dichroic dye of the light polarizing layer.

16. The method of claim 15, wherein insolubilizing and stabilizing the dichroic dye comprises:
contacting the light polarizing layer with an aqueous solution prepared from γ-aminopropyltrimethoxysilane and/or γ-aminopropyltriethoxysilane; and
heating the contacted light polarizing layer between about 60 degrees Celsius and about 140 degrees Celsius to impregnate the light polarizing layer with the γ-aminopropyltrimethoxysilane and/or γ-aminopropyltriethoxysilane.

17. The method of claim 16, wherein insolubilizing and stabilizing the dichroic dye further comprises:
contacting the heat treated light polarizing layer with an aqueous solution of an epoxyalkyltrialkoxysilane;
reacting the epoxyalkyltrialkoxysilane to condense and/or polymerize the epoxyalkyltrialkoxysilane; and
heating the reacted epoxyalkyltrialkoxysilane between about 60 degrees Celsius and about 220 degrees Celsius to impregnate the light polarizing layer with the reacted epoxyalkyltrialkoxysilane.

18. The method of claim 13, further comprising disposing an adhesion promoting primer layer on the light polarizing layer before forming the thick polymeric first layer.

19. The method of claim 13, wherein forming the thick polymeric first layer on the light polarizing layer comprises irradiating a radiation-curable (meth)acrylate composition comprising about 40 to about 90 weight percent of a reactive diluent vinylic monomer.

20. The method of claim 19, wherein the reactive diluent vinylic monomer comprises hydroxyl ethyl methacrylate, isobornyl acrylate, acrylic acid, tetrahydrofurfuryl acrylate, or a mixture or blend thereof.
